(19) United States
(12) Patent Application Publication
(10) Pub. No.: US 2026/0162169 A1
(43) Pub. Date: Jun. 11, 2026

(54) SYSTEMS AND METHODS FOR NARRATIVE GENERATION FROM EMBEDDINGS

(71) Applicant: Royal Bank of Canada, Toronto (CA)

(72) Inventors: Frederick Tung, North Vancouver (CA); He Zhao, Richmond (CA); Ruizhi Deng, Coquitlam (CA)

(21) Appl. No.: 19/417,115

(22) Filed: Dec. 11, 2025

Related U.S. Application Data
(60) Provisional application No. 63/730,797, filed on Dec. 11, 2024.

(51) Int. Cl. G06Q 30/0601; G06N 3/0475; G06N 3/0895

(52) U.S. Cl. CPC G06Q 30/06311; G06N 3/0475; G06N 3/0895

(57) ABSTRACT

Systems and methods for narrative generation. Data representations in a first data domain are received. The data representations of the first data domain are transformed into data representations of a second data domain by an adapter. Narratives corresponding to the data representations can be generated using a large language model by interpreting the data representations of the second data domain.

### CROSS-REFERENCE TO RELATED APPLICATIONS

The present disclosure claims priority to and benefit of U.S. provisional patent application No. 63/730,797, filed on Dec. 11, 2024 and entitled “SYSTEMS AND METHODS FOR NARRATIVE GENERATION FROM EMBEDDINGS”, the entirety of which is hereby incorporated by reference herein.

### TECHNICAL FIELD

The present disclosure relates to the generation of narratives from embeddings and in particular to the generation of narratives by interpreting embeddings comprising data representations of events using one or more machine learning models.

### BACKGROUND

In many modern applications, understanding and predicting the behavior of clients (which may refer to individual users, businesses, or user accounts) is crucial for delivering personalized services, optimizing marketing efforts, and providing tailored recommendations. Various systems have been proposed to analyze and model client data, such as demographic details, transactional history, browsing patterns, and social interactions.

Traditionally, client representations were built using explicit features such as age, gender, location, and purchase history. These representations were manually crafted, often requiring significant domain expertise to select and define the most relevant attributes. While such systems provided basic insights, they lacked the ability to capture complex patterns and relationships in the data, limiting their effectiveness in predictive modeling or personalization.

Further, interpreting these client representations, for example to generate narratives, requires significant knowledge and expertise both in client behavior and in the field to which the client representations pertain. Moreover, for a holistic understanding of the client representations, an enormous volume of data may be required to be analyzed or processed. As such, client representation interpretation can be costly, inefficient, and challenging.

Accordingly, systems and methods that enable the generation of narratives from client representations remain highly desirable.

### SUMMARY

In accordance with one aspect of the present disclosure, a narrative generation method is provided, comprising: receiving data representations of a first data domain; transforming the data representations of the first data domain by mapping the data representations of the first data domain to data representations of a second data domain using an adapter; and generating one or more narratives corresponding to the data representations of the second data domain by interpreting the data representations of the second data domain using a large language model (LLM).

In some aspects, the data representations of the first data domain comprise vector embeddings in the first data domain and the data representations of the second data domain comprise vector embeddings in the second data domain.

In some aspects, the vector embeddings in the second data domain comprise language token embeddings.

In some aspects, the vector embeddings in the first data domain correspond to a first vector dimension and the vector embeddings in the second data domain correspond to a second vector dimension.

In some aspects, the adapter is configured to map vectors from the first vector dimension to the second vector dimension.

In some aspects, the adapter is a first neural network trained to map the vectors from the first vector dimension to the second vector dimension.

In some aspects, the adapter is a multi-layer perceptron network.

In some aspects, the data representations of the first data domain comprise sequential events.

In some aspects, the data representations of the first data domain are generated by characterizing the sequential events using a second neural network.

In some aspects, generating the one or more narratives using the LLM comprises: generating an input prompt for interpreting the data representations of the second data domain comprising the data representations of the second data domain; and processing the input prompt with the LLM.

In some aspects, the input prompt is an input vector.

In some aspects, the input prompt comprises: a first prompt for providing the LLM with background, context, or role for interpreting the data representations of the second data domain; and a second prompt defining the one or more narratives to be generated by the LLM.

In some aspects, the second prompt is generated by a second LLM.

In some aspects, the input prompt is generated according to a prompt template comprising placeholders for the data representations of the second data domain; and the input prompt defines one or more rules for the one or more narratives.

In some aspects, the adapter has been trained by: generating ground truth narratives from training sequential events using the LLM for evaluation against the one or more narratives generated using the LLM by interpreting the data representations of the second domain.

In some aspects, each ground truth narrative comprises a sequence of tokens; the adapter has been trained by having the LLM generate tokens of the sequence of tokens in sequential order; and the adapter has been trained using a loss function comprising negative log-likelihood of the tokens.

In some aspects, the data representations of the first data domain comprise financial transactions and interpreting the data representations of the second data domain comprises processing the financial transactions using the LLM.

In some aspects, the one or more narratives comprise: a financial recommendation based on the financial transactions, a description of the financial transactions; an analysis of the financial transactions, or combinations thereof.

In accordance with another aspect of the present disclosure, a method of training machine learning models for use in narrative generation is disclosed, comprising: generating ground truth narratives from a plurality of sequential events using a large language model (LLM); training an adapter to generate data representations of a second data domain from data representations of a first data domain for interpretation by the LLM by: generating a plurality of training data representations of the second data domain for a plurality of training data representations of the first data domain corresponding to the plurality of sequential events; generating a plurality of training narratives by interpreting the plurality of training data representations of the second data domain using the LLM; and updating weights of the adapter based on a comparison of the plurality of training narratives against the ground truth narratives.

In accordance with another aspect of the present disclosure, a system for performing data interpretation is provided, the system comprising at least one processing unit configured to perform the method of any one of the above aspects.

In accordance with another aspect of the present disclosure, at least one non-transitory computer readable medium is provided, the at least one non-transitory computer readable medium having stored thereon computer instructions, which, when executed by at least one processor, causes the at least one processor to perform the data interpretation method of any one of the above aspects.

### BRIEF DESCRIPTION OF THE DRAWINGS

Further features and advantages of the present disclosure will become apparent from the following detailed description, taken in combination with the appended drawings, in which:

FIGS. 1-2 depict a system for generating narratives from data representations, according to example embodiments.

FIG. 3 depicts a method of generating narratives from data representations using the system of FIGS. 1-2, according to an example embodiment.

FIG. 4 depicts training of machine learning models in the system of FIGS. 1-2 for generating narratives, according to an example embodiment.

FIG. 5 depicts a method of training machine learning models in the system of FIGS. 1-2, according to an example embodiment.

FIG. 6 depicts a method of generating embeddings from data representations, according to an example embodiment.

It will be noted that throughout the appended drawings, like features are identified by like reference numerals.

### DETAILED DESCRIPTION

Recently, machine learning models have been employed to automatically generate client representations, for example as data representations. Techniques such as collaborative filtering, matrix factorization, and neural networks can be utilized to create client embeddings, such as lower-dimensional vector representations that capture clients' behaviors and preferences in a way that is useful for various downstream applications. These embeddings can enable more accurate predictions, such as recommendations for products or services, but still face challenges related to scalability, interpretability, and adaptability.

The interpretation of client representations and data representations in general, for example how to understand and extract meaningful insights from these high-dimensional vector representations, remains a significant challenge. Often, the data representations can be dense vector(s) that encode complex patterns but are difficult to interpret directly. As a result, there is a need for improved systems and methods for interpreting these representations in a manner that is understandable to both end-users and businesses.

In accordance with the present disclosure, systems and methods for interpreting client representations to generate narratives therefrom are provided. It should be noted that client representations are referenced herein as an example data representation that may be interpreted and that the present disclosure is also generally applicable for other types of data representations. Data representations may be a series of data that captures one or more events, actions, interactions, or items, for example as a list or sequence. Data representations may exist in various forms, for example as raw time-series data, raw tabular data, raw logs, and embeddings such as vectors. The data representations may be ordered or sorted, by example according to data type, data of each event, action, etc, or an alphabetical ordering based on a data attribute, or may be unordered. In one example, data representations for an entity corresponding to a financial account may comprise time series data of a plurality of sequential financial transactions.

In accordance with a broad aspect, data representations of a first data domain can be received. The data representations may be raw data or data representations which have been processed, for example by a machine learning model such as a neural network, an autoencoder, a large language model (LLM), etc. The data representations of the first data domain can be processed by an adapter, which can transform or map the data representations from the first data domain to a second data domain. An LLM can process the transformed data representations to interpret or analyze the data representations as to generate one or more narratives.

It should be noted that, as used herein unless otherwise specified, a data domain may refer to a modality of data such as a data type or format, for example, image, text, audio, video, time series data, graph data; and/or may refer to a feature space of data, which can be a multi-dimensional space created by the features (e.g., variables or attributes) of the data representations. For example, each feature may be treated as a dimension in the feature space, and the data points or samples (e.g., each event, action, etc. in the data representation) can be represented as vectors in the feature space. As such, the feature space may be a mathematical representation of all possible combinations of the features in the data representations. As another example, a data domain may correspond to a particular feature space having a set of properties or parameters such as feature/attribute representation of the data representations, vector size or space, and dimensionality while another data domain may have a different feature space having a different set of properties or parameters.

As used herein, a “domain” is a grouping of one or more types of interactions having a defined common characteristic that is shared for all elements or data in the domain. One domain is distinct and discrete from another domain (“distinct discrete domains”) if the two domains have a different common characteristic. A difference in common characteristics may be an inherent real difference which is recognized in defining the characteristic or difference, or may be an arbitrarily defined difference chosen by an implementer of the methods described herein according to the context and purpose. Certain illustrative non-limiting examples follow. For example, where an entity is a hospital there may be a single domain for “all arrivals” or there may be distinct discrete domains for each of ambulance arrivals, walk-in arrivals and helicopter arrivals, where the common characteristic for each of the distinct discrete domains is a particular method of arrival (e.g., ambulance, walk-in, and helicopter). Where an entity is an individual, there may be one distinct discrete domain for bank account transactions and another distinct discrete domain for credit card transactions, or there may be distinct discrete domains for each of chequing accounts and savings accounts (where the common characteristic for each of the domains is a particular account type), or for each credit card of a particular brand even if offered by the same bank. Where an entity is a monitored wildlife refuge, there may be one domain for all avians, or there may be distinct discrete domains for different species of avians with each species being a common characteristic. Where an entity is a ride-share vehicle within a service that provides both transportation (e.g., of humans) and delivery services (e.g., food delivery), there may be a single domain for all trips, or there may be distinct discrete domains for each of transportation trips and delivery trips, with the type of transported item being the common characteristic. The distinct discrete domains may be mutually exclusive, but in some contexts they may overlap. For example, a hospital may have distinct discrete domains for each of ambulance arrivals, walk-in arrivals and helicopter arrivals and may have a further distinct discrete domain for heart attack arrivals (which overlaps the other hospital domains and where the arrivals are for people with heart attacks, which is the common characteristic) but each is still a distinct discrete domain. Or, where an entity is an individual, there may be distinct discrete domains for each of credit card, mortgage, and line of credit (each being a common characteristic for a set of data), and then another distinct discrete domain for credit products generally.

The term “data representation” is used herein to refer to data or representations thereof that describe, characterize, or correspond to a particular set of data, such as data associated with a particular entity. An entity may be an individual, an object, an item, an organization, a location, an event, etc, which can have data associated therewith. Data representations may be a series of data such as time series data that capture one or more events, actions, interactions, or items, for example as a list or sequence, descriptive of an entity. Data representations may exist in various forms, for example as time-series data, tabular data, logs, textual descriptions, lists, numerical data, and embeddings such as vectors. Embeddings derived from raw time series data are an example of data representations. The data representations may be ordered or sorted, for example according to data type, date of each event, action, etc., or an alphabetical ordering based on a data attribute, or may be unordered. In some embodiments, data representations can comprise natural language text and descriptions. The text and descriptions may be sentences, paragraphs, bullet points, etc. Data representations can comprise both raw data as well as processed data. For example, for a set of data representations comprising raw data, embeddings generated from the raw data also comprise part of the data representations, as they also describe the entity, albeit in a different manner than the raw data itself.

As used herein, narratives may refer to insights or analysis that are derived or interpreted from data such as data representations that are presented in a coherent and human-readable and relevant and logical in the context of the data representations. Narratives can highlight patterns, trends, or significant events and can make the data representations more accessible and meaningful and easy to understand to a user, for example one that is not familiar with the data representations or the field associated therewith. Narratives can transform large volumes of complex, raw data into a structured and understandable format such as natural language key points or sentences that provide context, insight, and actionable conclusions. In some embodiments, narratives may also comprise recommendations or suggestions formulated based on the data representations. In particular, narratives may be structured sentences, phrases, or paragraphs in natural language describing the insights or analysis and providing additional context and detail (e.g., “the client has had a steady stream of incoming deposits over a long period of time and is unlikely to default on loan payments”) as opposed to direct, simplified data (e.g., “low delinquency”).

The present disclosure can provide various benefits. In particular, automated interpretation of a large volume of complex data to generate insightful narratives can be achieved. Accordingly, human resources in time and energy can be saved. Additionally, it is possible to provide insightful narratives even if the user does not have any experience or expertise in data analytics or the field pertaining to the data. For example, to generate narratives based on financial data such as a series of transactions, the user does not need to be knowledgeable in finance or accounting. Further, the present disclosure can overcome difficulties in data processing by machine learning models. For example, a LLM may be preferable for generating natural language narratives. However, the LLM may be trained to operate in a different data domain than the data representations that need to be interpreted. By utilizing an adapter, the data representations can be transformed into a data domain that the LLM is familiar with or trained to operate on.

More specifically, client representations (such as embeddings) can be versatile input features that can be generalized to diverse applications. Embeddings may be preferable for machine learning processing. In particular, as embeddings comprise condensed information extracted from raw data, they are more efficient to store and to process computationally. Embeddings are also generally more secure as they are not easily interpreted when compared to natural language even when exposed or intercepted. However, client embeddings may be difficult to interpret directly, for example by machine learning models such as LLMs, and may be treated as “black box” features. This opaqueness can be undesirable in high-stakes application areas such as credit adjudication in the field of finance, which often have enhanced explainability requirements from both internal stakeholders and external regulators. The present disclosure provides systems and methods that can leverage LLMs to make client embeddings interpretable by transforming them into client narratives. Accordingly, new approaches for generating human-friendly explanations of client embeddings in natural language, making them accessible to non-specialist audiences can be enabled by the present disclosure.

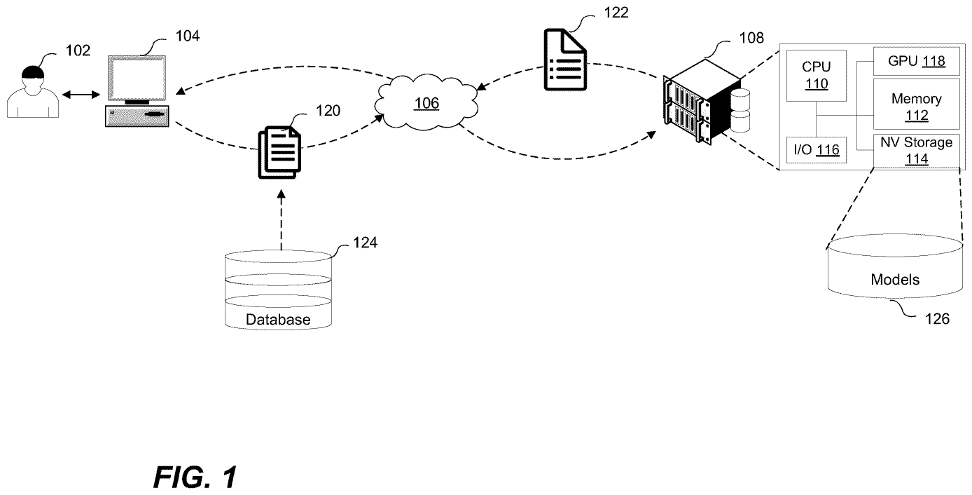

Embodiments are described below, by way of example only, with reference to FIGS. 1-6.

FIG. 1 depicts a system for generating narratives from data representations, according to an example embodiment, shown in FIG. 1 as one or more servers 108. The implementation of the servers 108 is not restrictive and servers 108 may be an on-premises server, cloud-based server, or a hybrid thereof, for example. A user 102 may interact with the servers 108 via a device 104 over a communications network 106 (e.g., the internet). The device 104 may be a computer, as depicted in FIG. 1, but is not restricted to those devices expressly shown and may be any suitable device known in the art such as smart phones and tablets. The servers 108 may provide a graphical user interface (GUI) on the device 104 for ease of communication and operation control by the user. The implementation of the GUI is not restrictive and may be, for example, a mobile/computer application or a web page. The GUI can be used to provide input to and receive output from the servers 108. Additionally or alternatively, other user interfaces, such as an audio interface that allows receipt and processing of spoken commands, and that outputs spoken narratives, may be used.

The user 102 may be interested in generating narratives by interpreting the data representations using the servers 108. In particular, the user 102 may wish to interpret data representations 120 to determine narratives 122. The data representations 120 can be raw data or processed data, for example embeddings or data represented as vectors. The narratives 122 may be used to provide insights into the data representations 120 and can allow the user 102 to make informed decisions based on the data representations 120. In some embodiments, the data representations 120 can be financial data corresponding to sequential events such as a series of financial transactions or activities, for example associated with a particular entity. The narratives 120 may be insights or analysis of the financial transactions, for example descriptions thereof, patterns or key features thereof; inferences/conclusions based thereon, recommendations based thereon, or combinations thereof.

The servers 108 may be configured to interpret the data representations 120 to generate the narratives 122. In particular, the data representations 120 may be processed by one or more machine learning models 126 to generate the narratives 122, as described further herein. The machine learning models 126 may each be an artificial intelligence (AI) model or algorithm, a machine learning model or algorithm, and may comprise, in particular, an LLM and a multi-layer perceptron (MLP) network. The narratives 122 may be returned to the user 102 from the server 108 to the device 104 for display, for example over the communications network 106. In some embodiments, the narratives 122 may be further processed, for example using an LLM, to generate emails, recommendations, insights, etc. based thereon.

According to the present disclosure, the data representations 120 may be provided to or retrieved by the servers 108, for example from the device 104. The data representations 120 can also be retrieved from one or more external devices and/or one or more databases, such as a database 124, comprised by the servers 108 or the device 104, or coupled thereto, for example over the communications network 106. The database 124 may securely store data representations 120 to prevent unauthorized access and loss of sensitive data and may automatically store and sort the data representations as the associated event, actions, etc., occur. The data representations 120 and the narratives 122 may be requested and received using an application programing interface (API) via requests/calls and responses, for example over the communications network 106, although other forms of communication such as Bluetooth and near-field communication are possible as well.

In a particular implementation, the servers 108 each comprise a central processing unit (“CPU”) 110, a non-transitory computer-readable memory 112, non-volatile storage 114, an input/output interface 116, and a graphical processing unit (“GPU”) 118. The non-transitory computer-readable memory 112 comprises computer-executable instructions stored thereon at runtime which, when executed by the CPU 110, configure the server to perform the herein described processes of narrative generation. The non-volatile storage 114 has stored on it computer-executable instructions that are loaded into the non-transitory computer-readable memory 112 at runtime. The input/output interface 116 allows the servers 108 to communicate with one or more external devices such as the device 104 (e.g., via network 106). The non-transitory computer-readable memory 112 may also have stored thereon the machine learning models 126. The GPU 118 may be used to control a display and may be used to process the data representations 120 to generate the narratives 122, including for example by running the machine learning models 126 to interpret the data representations 120, as described further herein. In some embodiments, the machine learning models 126 may be stored at one or more separate servers. Accordingly, it is possible to interface with the modules and/or the models 126 comprised therein for generating the narratives 122 through the use of APIs. The servers 108 and the device 104 may each provide a communications interface which allows software and data to be transferred, for example between the servers 108 and the device 104 over the communications network 106.

The CPU 110 and GPU 118 may be one or more processors or microprocessors, which are examples of suitable processing units, which may additionally or alternatively comprise an artificial intelligence accelerator, programmable logic controller, a microcontroller (which comprises both a processing unit and a non-transitory computer readable medium), neural processing unit (NPU), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

It should be noted that while FIG. 1 depicts the device 104 and the servers 108 as separate entities coupled over the communication network 106, the device 104 and servers 108 may also be coupled directly/physically using cable(s) for data transfer. In some embodiments, the servers 108 may also be the device 104 or comprise the device 104 (e.g., the servers 108 being implemented as a part of a computer system). In such an embodiment, the servers 108 may directly retrieve the data representations 120 (as well as any other required data) from fixed local storage or removable local storage.

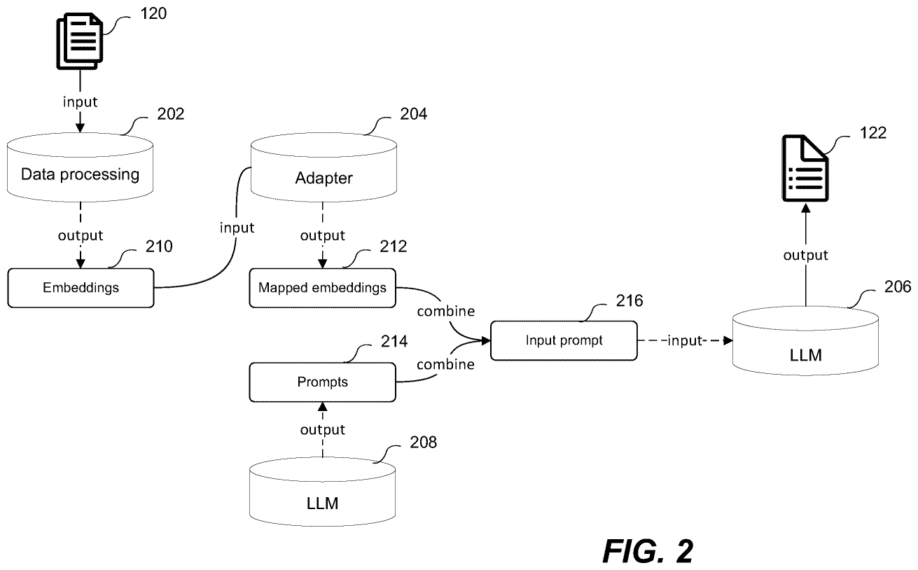

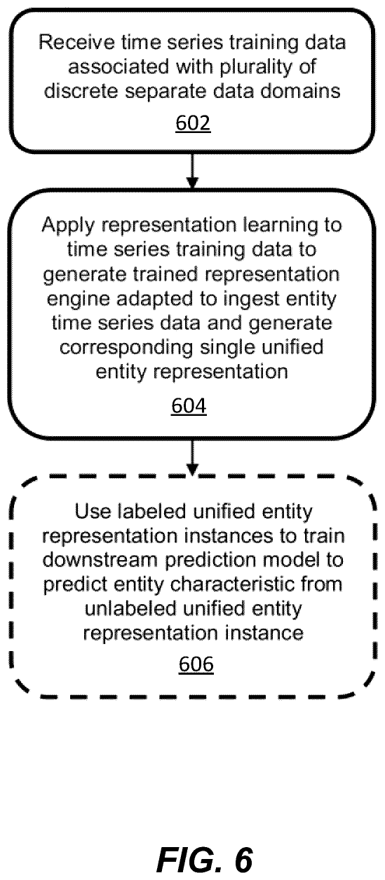

Referring now to FIG. 2, the data representations 120 can comprise raw data such as tabular data, time-series data or logs and may be processed to generate embeddings 210 corresponding or representative of the data representations 120. To generate the embeddings 210, data representations 120 may be processed by data processing module 202, as depicted in FIG. 2. Specifically, the data representations 120 may be discrete event sequence data, particularly financial discrete event sequence data such as a series or sequence of transactions or financial activities. As another example, the data representations 120 may be a list of purchases or a list of products on a particular wish list. In some embodiments, the data representation may comprise natural language text such as descriptions in sentence, paragraph, and/or bullet form. In particular, the data processing module 202 may be one or more neural networks configured to process, characterize, transform, and/or standardize the data representations 120 into the embeddings 210 representation thereof. The data processing module 202 and the generation of embeddings 210 is described further herein with respect to FIG. 6. Data representations 120 can comprise a group of at least one data representation from which narratives 122 to be generated, where the group can be referred to as a set. For example, a set of data representations can correspond to the transactions of a particular account for which narratives are to be generated.

The embeddings 210 may represent higher dimension complex data, in this case the raw data of data representations 120 (e.g., words, time series-data, etc.), as lower-dimensional vectors in a continuous vector space. In particular, embeddings 210 may be dense representations of the data representations 120 and can comprise vectors comprising real-valued numbers, as opposed to sparse representations such as one-hot encoding, and where the (dense) vectors can be useful for capturing meaningful relationships or patterns within the data representations 120. That is, the data representations 120 may be transformed into number representations such that the embeddings 210 are the data presentations 120 in vector form. For example, within the data representation 120, each entry (e.g., each transaction), each word, each data event in time series-data/logs, each row/column/cell in tabular data, etc. may be mapped to one or more numbers where the embeddings 210 comprise a plurality of vectors of the mapped numbers corresponding to the data representations 210, where each vector can represent an entry, a word, a data event, a row/column/cell etc. Specifically, the data representations 120 may be tokenized by the data processing module 202 to generate the embeddings 210, where the tokens can refer to the individual units or elements that data is broken down into during the preprocessing step (e.g., each entry, each word, data event, each row/column/cell, etc. of the data representation 120). Accordingly, each token can correspond to a vector, which itself corresponds to a position in the vector/embeddings space.

The embeddings 210 can reduce the size of high-dimensional data to lower-dimensional vectors to better facilitate data processing and computationally efficient processing thereof while preserving the original information in the data representations 120. In particular, the embeddings 210 (e.g., the vectors) may be constructed such that similar data points (e.g., similar words, images, or users) are placed closer together in the vector space where the distance between vectors represents semantic similarity. For example, in word embeddings, words with similar meanings can be represented by vectors that are close to each other in the vector space.

The embeddings 210, or alternatively the raw data of data representations 120 can be processed by an adapter 204 to generate the mapped embeddings 212. In particular, the raw data and the embeddings 210 may correspond to or be represented in a first data domain, where the adapter 204 processes the raw data or embeddings 210 such that they are transformed or mapped to a second data domain, for example as the mapped embeddings 212. That is, the embeddings 210 may represent the data representations 120 in a first feature or vector space (e.g., first data domain), for example having a first set of parameters thereof, while the mapped embeddings 212 may represent the data representations 120 in a second feature or vector space (e.g., second data domain), for example having a second set of parameters thereof. The adapter 204 can generate the mapped embeddings 212 by mapping each of the vectors comprised in the embeddings 210, corresponding to the first feature space, into corresponding vectors in the second feature space as the mapped embeddings 212. More specifically, the first and second feature spaces may have different dimensionality, and as such the adapter 204 can transform vectors of a first dimension (e.g., first data domain) in the embeddings 210 into vectors of a second dimension (e.g., second data domain) as the mapped embeddings 212, where the dimension of a feature or vector space can refer to a number of features or attributes that describe a data point or vector in the feature space. Further, vectors in the first feature space may have different magnitude, direction, tokenization (e.g., how the words, items, actions, etc. are broken down into tokens) from vectors in the second feature space as well as having different basis vectors. As such, the adapter 204 can map the vectors in the embeddings 210 into the corresponding vectors in the mapped embeddings 212 by mapping the vectors to account for the differences in these parameters or into the proper vectors having the corresponding parameters. More generally, the vector representations of the data representations 120 of the first data domain (e.g., embeddings 210), can be converted into vectors in the second data domain (e.g., mapped embeddings 212) corresponding to the data representations 120 being represented in the second data domain (e.g., feature space) by the adapter 204. In cases where data representations in the form of raw data are processed by the adapter 204, the adapter 204 can perform tokenization and vectorization to generate vectors of the second data domain from the raw data as the mapped embeddings 212. In some embodiments, the adapter 204 may also transform the mapped embeddings 212 into natural language text, for example by converting the mapped vectors into natural language text or directly transforming the embeddings 210 into natural language.

As depicted in FIG. 2, the narratives 122 are generated by a LLM 206. As such, in order to process the data representations 120 using the LLM 206, the mapped embeddings 212 should be in a format that the LLM 206 is trained to operate on. For example, the second data domain may correspond to the data domain that the LLM 206 is trained on. In some embodiments, the adapter 204 is configured to generate mapped embeddings 212 as language token embeddings from the embeddings 210, which are more suitable for LLM processing. The adapter 204 can be a machine learning model such as a neural network. In particular, the adapter can be a MLP network or recurrent neural network (RNN) trained to generate vectors in the second data domain, for example the mapped embeddings 212, using vectors in the first data domain as input, for example the embeddings 210. The MLP network may be a feedforward neural network consisting of input, hidden, and output layers, where each neuron in the hidden layers applies a non-linear activation function to learn patterns in the embeddings 210 to generate the mapped embeddings 212. Each neuron in the network may represent a feature. For example, the number of nodes may correspond to the dimension size (e.g., number of dimensions) in the embeddings 210. To train the MLP network as the adapter 204, training data comprising embeddings may be provided to the MLP network. The adapter can be trained and fine-tuned using a negative log-likelihood loss, as described further herein. Alternatively, the adapter 204 may be a mapping or transformation algorithm or function that can perform vector mapping, for example, to transform vectors of one dimension size to corresponding vectors in a second dimension size.

The mapped embeddings 212 can be processed by the LLM 206 to generate the narratives 122. To facilitate the LLM 206 in interpreting mapped embeddings 212 corresponding to the data representations 120, the mapped embeddings may be incorporated in an input prompt 216. In particular, to interact with the LLM 206, the input prompt 216 can be formulated using dialogues with concise and well-structured language, similar to chatting with the LLM 206. The input prompt 216 may be displayed to the user 102, which can also help the user 102 in understanding the task being performed and the narratives 122 being generated, but is not required. A number of different LLMs may be implemented as the LLM 106; for example, the LLM 206 can be implemented using llama-3™, Phi3 Mini™, OpenAI™ etc. LLMs. Different LLMs, for example LLMs with different architectures, can each have their own specialized chatting template or format requirement for the input prompt 216. As such, the input prompt 216 may be adapted depending on the prompt requirement of the specific LLM that is used for processing to accordingly build the dialogue using specially crafted prompts. For example, llama-3™ based LLMs can pre-define three roles for each conversation session, which are {system, user, assistant}, and set up a discussion panel among these roles, where the system role and user role correspond to and can be fulfilled by the input prompt 216 and the assistant role corresponds to the output of the LLM 206 (e.g., the narratives 122).

In some embodiments, the input prompt 216 can be formulated as a conversation in a way similar to talking to professionals relevant to the field of the data representations 120. For example, to interpret data representations 120 pertaining to financial data such as financial transaction, the input prompt 216 may be formulated as a conversation with a financial professional. For example, the input prompt 216 may frame the LLM 206 as a professional in as field pertaining to the data representations 120 or otherwise limit or identify the field pertaining to the data representations 120. As such, the LLM 206 can better understand the context of the data representations 120, for example the terminology and data in the context of the related field (e.g., finance) and accordingly generate narratives that are more relevant to the field (e.g., finance). That is, the input prompt 216 can comprise instructions for the LLM 206 to generate the narratives 122, where the instructions are oriented to a field relevant or pertaining to the data representations 120 (e.g., mapped embeddings 212) by providing the LLM 206 with a specialized role in the field or otherwise identifying the field.

An example input prompt 216 and the corresponding narratives 122 generated by the LLM 206 are shown below in Table 1. In this example, the LLM 206 is implemented using the llama-3™ LLM. In the example shown in Table 1, financial narratives are generated using a series of financial transactions captured as the data representations 120.

TABLE 1
Example Input Prompt and Generated Narratives

| Role | Messages |
|---|---|
| System | You are an expert in the financial sector who has extensive |
| | knowledge on personal chequing transaction data and can |
| | provide deep analysis on the client's financial |
| | situation. <STOP> |
| User | Here is the embedding of personal chequing transaction |
| | history: <embeddings>. Please generate a high-level |
| | description of this client's financial behaviour. <STOP> |
| Assistant | The account holder shows a balanced approach to managing |
| | income and expenses. They prioritize essential expenses like |
| | rent, utilities, and groceries while also allowing for |
| | discretionary spending on dinning out, shopping and |
| | subscriptions. Regular savings transfers indicate a focus on |
| | financial security and planning. <STOP> |

In Table 1, <STOP> indicates the end of the sentence, prompt, or message. The mapped embeddings 212 are provided to the LLM 206 as part of the input prompt 216, shown in Table 1 as <embeddings> for simplicity's sake. The messages from the roles identified as system and user correspond to the input prompt 216, and the message from the assistant corresponds to the narratives 122, interpreted from the mapped embeddings 212 by the LLM 206, which is a sequence of high-quality client narratives. It should be noted that, as depicted in Table 1, the input prompt 216 can comprise natural language messages with the mapped embeddings 212 embedded therein as vectors (e.g., combination of natural language text and vectors). The LLM 206 can ingest the input prompt 216 as language token embeddings, as the vectors in the mapped embeddings 212 are in the data domain that the LLM 206 is trained to operate on. In some embodiments, it is also possible to represent the entirety of the input prompt 216 using vector representation. For example, vector representations can be generated by tokenizing the natural language text comprised in the input prompt 216. In particular, a text encoder can be used to encode the input prompt 216 into vectors. In some embodiments, the entirety of the input prompt 216 can be represented using natural language, for example in cases where the mapped embeddings 212 are in natural language or by converting the mapped embeddings 212 to natural language.

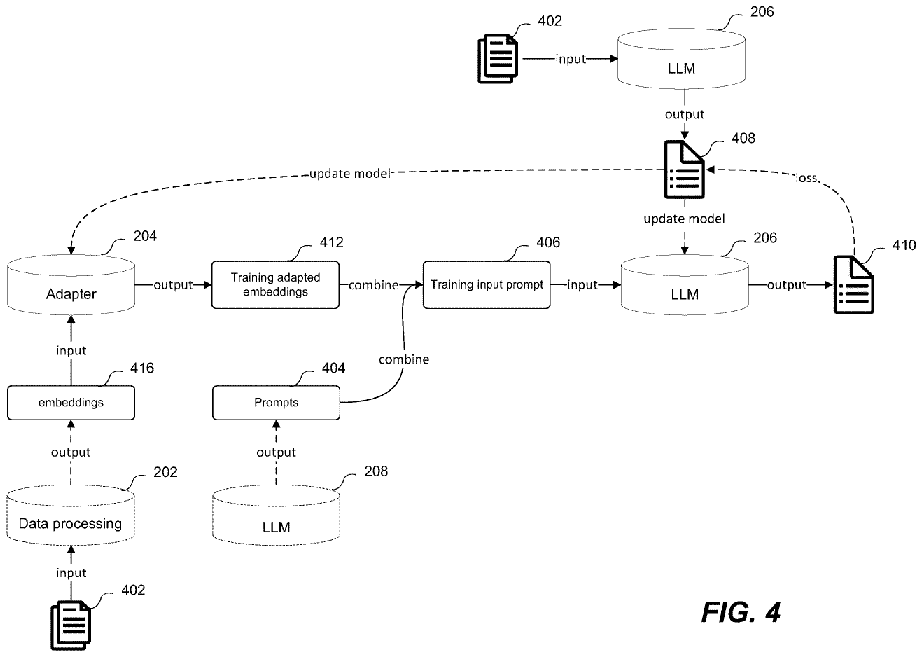

An example of mapped embeddings 212 corresponding to financial activities represented as natural language text is shown below:
   |transaction date|transaction category|transaction amount
   |20xx-08-03|External Pre-Authorized Payment (Chargeable)|173.15$|
   |20xx-08-04|Cheque Deposit|500.0$|
   |20xx-08-07|External Pre-Authorized Payment (Chargeable)|600.0$|
   |20xx-08-07|Internal Transfer of Funds to Deposit between Accounts Online|8900.0$
   |20xx-08-07|Manual Payment of Loan using Internet Banking|13000.0$|
   |20xx-08-09|Cheque Deposit|1272.0$|
   |20xx-08-15|Deposit of Payroll, Government, Tax, and Other Funds|15.0$|
   |20xx-08-16|Loan Interest Charged|13.13$|
   |20xx-08-21|Cheque Deposit|1600.0$|
   |20xx-08-23|Recurring Seniors Rebate|7.0$|
   |20xx-08-23|Monthly Banking Fee|10.95$|
   |20xx-08-28|External Pre-Authorized Payment (Chargeable)|399.97$|
   |20xx-08-31|E-Transfer Received into the Account Holder's Email|4175.43$|
   |20xx-09-01|Cash Withdrawal from Personal Touch Banking|13.2$|
   |20xx-09-01|Cash Withdrawal from Personal Touch Banking|256.05$|
   |20xx-09-01|External Pre-Authorized Payment (Chargeable)|310.0$|
   |20xx-09-05|External Pre-Authorized Payment (Chargeable)|145.78$|
   |20xx-09-05|External Pre-Authorized Payment (Chargeable)|175.0$|
   |20xx-09-08|Scheduled Internal Payment to Credit Card or InvestEase|2935.91$|
   |20xx-09-12|External Pre-Authorized Payment (Chargeable)|537.94$|
   |20xx-09-13|E-Transfer Received into the Account Holder's Email|242.13$|
   |20xx-09-15|External Pre-Authorized Payment (Chargeable)|483.0$|
. . .
   Specifically, the mapped embeddings 212 may be derived from text in a tabular format. For example, each row in the table occupies a line, and columns can be separated by delimiters like commas or vertical bars. The first line of the table in text format may comprise a header showing the name of each column corresponding to the type of data in each column, separated by the same delimiter. The rows of the table can be ordered or grouped by a column of the table such as date or the data type. In the above example, the table comprises a series of financial transactions as the text representations of the mapped embeddings 212 where entries are ordered based on the time of occurrence. Transforming the mapped embeddings 212 to natural language and ordering the events, activities, etc. comprised therein prior to ingestion by the LLM 206 may facilitate the interpretation of the data representations 120 by the LLM 206. As described further herein with respect to FIG. 4, natural language data representations, as described above, may be used in place or vector mapped embeddings for the training of the LLM 206.

As shown in Table 1, the input prompt 216 can comprise a plurality of prompts 214, such as a first and a second prompt. In particular, the first prompt may be a system prompt, for example, corresponding to the message provided as the system role in Table 1. The system prompt can provide the LLM 206 with background, context, or a role for interpreting the data representations 120 captured as the mapped embeddings 212, for example, by identifying the relevant field of expertise pertaining to the data representations 120, as described above. The system prompt can also provide the LLM 206 with a high-level description of the task that it needs to perform, for example, providing insights or analysis in a particular field without specifying the specific narratives that the LLM 206 should generate. Accordingly, the system prompt can give high-level instructions to LLM 206, set the tone of the narratives 122 (e.g., the LLM response) as well as provide a general description of the second prompt (described below), for example, a context of the second prompt and the data representations 120. Examples of the system prompt for the interpretation of finance-based data representations 120 are as follows:
“You are a expert in personal finance and banking in a Canadian bank. You will be presented with transaction histories of Canadian clients' bank accounts and asked to answer questions about the client or summarize the client profile based on their transaction history”; and
“You are a expert in personal banking, consumer behaviours, and credit card reward programs. You will be presented with the transaction histories of a Canadian client's chequing account and credit card. You will also be presented eight offers the client can redeem credit card rewards points for. Please rank the preference of the clients' over the eight offers from high to low based on the financial activities and spending habits of the client”.
   As shown in the second example, the system prompt can also comprise a general description of the narratives 122 for generation by the LLM 206 or comprise a general overview/description of the narratives 122 or type thereof.

The second prompt may be a narrative prompt comprising the mapped embeddings 212 and defining the specific narratives to be generated by the LLM 206. The narrative prompt can provide context for mapped embeddings 212, for example by describing what information is represented or encapsulated by the mapped embeddings 212 for improved LLM interpretation. In particular, the narrative prompt can provide more detailed and specific instructions to the LLM 206, for example by defining the specific type(s) of narratives to be generated and/or the specific contents of the narratives to be generated. That is, the narrative prompt can define the exact type of insights or recommendations to be generated as the narratives 122. For example, the narrative prompt can define the narratives 122 by requiring the LLM 206 to identify patterns/items of interest, identify key findings, as well as provide predictions/estimations/conclusions/recommendations. The narrative prompt can also define requirements or rules for the narratives 122 generated by the LLM 206. For example, the narrative prompt can define a data or file type for the narratives 122, a format/formatting for the narratives 122, or acceptable or unacceptable answers/choices/values for output as the narratives 122. The narrative prompt can be manually designed and may include generic natural language requests such as “Please assess the client's financial situation from the perspectives of income consistency, spending habits, savings behavior, existing financial obligations, and overall cash flow,” or give instructions with specific purposes such as “Please predict whether the client would be interested in redeeming the credit card reward point for flights based on the transaction history and explain the prediction with three reasons.” Some example requirements are shown below:
“Summarize the response using no more than X bullet points”;
“Enumerate the bullet points in the response from 1 up to X”;
“Do not use specific numbers or details from the provided data (e.g., mapped embeddings 212) in the response”;
“Provide your response in the format of a JSON file containing a list of items”;
“Each item in the response should correspond to one recommendation;
   “1) “recommendation_id”: the id of the recommendation in a single digit from 1 to X;
   2) “recommendation_rank”: the rank of the recommendation by preference in a single digit from 1 to X where 1 is the highest ranking and X is the lowest;
   3) “recommendation”: the content of the recommendation in a string;
   4) “reason”: the reason for the ranking of the recommendation in a string”;
“Do not include any additional text other than the JSON file”; and
“the valid recommendations are: 1) . . . , 2) . . . X) . . . ”.

The input prompt 216 can be generated by concatenating or combining the first and second prompts, or inputting them into the LLM 206 sequentially. Further, once the first prompt is provided to the LLM 206, multiple queries to the LLM 206 using only the second prompt are possible. For example, the user 102 may wish to generate a plurality of narratives 122 for a plurality of data representations 120 pertaining to the same field. In such a case, once the first prompt for identifying the field is processed by the LLM 206, the input of the first prompt to identity the same field for the LLM 206 for subsequent interpretation of subsequent data representations may be omitted (e.g., between narrative generation), as the relevant field or the role of the LLM 206 can be preserved between queries. As such, second prompts comprising the mapped embeddings 212 can be inputted sequentially until a set of data representations pertaining to a different field needs to be interpreted. In some embodiments, the system prompt may be omitted from the input prompt 216 entirely or be comprised as a part of the narrative prompt, for example in cases where the LLM 206 does not accept system prompts (e.g., Phi3 Mini™ LLM).

In some embodiments, the input prompt 216 may be generated according to a prompt template or to a particular format. For example, the input prompt may be generated as a concatenation of the first and second prompts (e.g., <system prompt>+<narrative prompt>), as described above. The first and second prompts may also be generated according to a particular prompt template, for example out of a plurality of prompt templates where the appropriate template may be determined automatically or selected manually by the user 102. As an example, the first prompt can correspond to one of a plurality of prompt templates each corresponding to a role-defining prompt of a particular field. The first prompt can then be selected based on the field pertaining to the data representations 120. For example, for-oriented data representations 120, a prompt defining the LLM 206 as a finance expert can be selected as the first prompt. The template can also correspond to the type of data in the data representations 120 as well as the desired type of narratives 122 to be generated. For example, a prompt template for the first prompt can specify that the data representations 120 (e.g., mapped embeddings 212) correspond to financial transactions to indicate the type of data as financial and also specify that the LLM 206 should be providing recommendations based on the transactions as to indicate the desired type of narratives 122 to be generated. The second prompt can also be generated according to one of a plurality of templates in a manner analogous to the process described with regard to the generation of the first prompt. For example, the second prompt can be selected as one of a plurality of templates based on the data representations 120 and the desired types of narratives 122 to be generated. For example, a prompt template for the second prompt may correspond to the generation of recommendations as the narratives 122, where the prompt template may list the number of available and acceptable offers as well as instructions to rank the recommendations. To generate a different type of narrative, a different prompt template corresponding to the desired narrative type may be used. As another example, a prompt template for the second prompt may describe the format or structure of the data representations 120, specifically the mapped embeddings 212, to help the LLM 206 better interpret the mapped embeddings 212. For mapped embeddings in a different format, a different prompt template corresponding to the particular format can be used. The templates for the second prompt can also comprise placeholders, for example to facilitate the insertion of the mapped embeddings 212 into the second prompt.

An example prompt template for the second prompt is shown below:
You will be presented a table of transaction histories in a client's bank account. The first row shows the name of each column and columns are separated by |. Below is the table
<mapped embeddings>
<narrative specifications>
In this example, the first line identifies the format of the mapped embeddings 212 as well as provides a brief description of the contents of the mapped embeddings 212. The mapped embeddings 212 for interpretation by the LLM 206 can be inserted in place of the placeholder <mapped embeddings>. Similarly, the desired type of narratives can also be inserted in place of the placeholder <narrative specifications>.

In some embodiments, one or more prompts 214, specifically the first and/or second prompts, can be generated using a second LLM 208. The implementation of the LLM 208 is not restrictive and may be a pre-trained LLM such as the Llama-3 LLM. The LLM 208 can generate queries targeting specific narratives to be generated by the LLM 206, for example, interpreting specific aspects of the mapped embeddings 212 or generating a specific type of narrative such as recommendations. This approach can leverage the prior knowledge of LLMs learned from massive amounts of data during pre-training. Some examples of prompts 214 generated by the second LLM 208 is shown alongside the corresponding input query to the LLM 208:

### Example 1

### Input Query:

I have the transaction history of a client's chequing account and credit card, which includes transaction amounts, categories or merchant names, and transaction dates. Additionally, I have eight offers available for the client to redeem credit card reward points, covering electronics purchases, flight redemptions, appliance and home decor purchases, gift card redemptions, and car rental redemptions. Please provide a list of prompts or instructions I can use to summarize or analyze the client's transaction history with a large language model to gain insights into the client's preferences regarding these eight offers, without asking for specific transaction details or numbers.

### Generated Prompt:

1. Identify the most frequent categories or types of transactions in the client's history to understand their spending habits and preferences, which may indicate which rewards offer would likely resonate more with them.
2. Determine if the client has a preference for online or in-person purchases, as online shoppers may prefer rewards redeemable in that environment, like electronics or gift cards, while those who make in-person purchases may favor rewards like car rentals.
3. Assess if the client makes regular purchases in categories related to electronics or home decor, as frequent transactions in these areas suggest a preference for electronics or home-related items, making them more likely to redeem rewards for similar products.
4. Determine if there is a pattern of travel-related expenses, such as flights or car rentals, as regular travel-related expenses indicate a lifestyle where rewards for flights or car rentals would be particularly appealing.
5. Identify if the client frequently purchases from merchants offering gift cards, as this could indicate an interest in flexible rewards, suggesting that the client might value the versatility of gift card redemption options.
6. Analyze if the client has shown consistent interest in appliance or home-related purchases, as a pattern of purchases in these categories may suggest a desire to upgrade or invest in home-related items, making rewards for appliances or decor more attractive.
7. Determine if the client has a seasonal or recurring trend in any category, like travel or electronics, as identifying cyclical spending habits could inform when the client is likely to redeem certain rewards, such as travel during holidays or electronics around new product releases.
8. Identify if the client has shown interest in high-value purchases that may align with electronics or travel rewards, as clients who make high-value purchases might be more inclined to redeem rewards that offer significant value.

### Example 2

### Input Query:

Please give me five prompts or instructions without additional text I can use along with the transaction history of a client's checking account if I would like to get some high-level insights on whether the client can afford more debt. The prompts or instructions should not ask for specific numbers of details.

### Generated Prompt:

1. Identify any patterns of recurring expenses that could impact the client's ability to service new debt.
2. Assess the client's average cash flow balance over time to gauge financial stability.
3. Evaluate the frequency and size of any large withdrawals or transfers that may indicate existing financial commitments.
4. Determine if there are any periods of significant account overdrafts or low balances.
5. Review the regularity and stability of income deposits to understand income reliability

As shown in the above examples, the queries provided to the second LLM 208 for generating the prompts 214 can specify the types of prompts 214 to be generated by the LLM 208 as well as requirements thereof, such as not including specific numbers or details in the prompts 214. The prompts generated by the LLM 208 may be used to generate the input prompt 216 directly or formatted and saved as prompt templates for later use.

Another example of an input prompt 216 is shown below, comprising mapped embeddings 212 pertaining to finance shown in natural language:
<|begin_of_text|><|start_header_id|>system<|end_header_id|>
Cutting Knowledge Date: December 20xx
Today Date: 26 July 20xx
<|eot_id|><|start_header_id|>systm<|end_header_id|>
You are an expert in personal banking, consumer behaviours, and credit card reward programs. You will be presented with the transaction histories of a Canadian client's chequing account and credit card. You will also be presented eight offers the client can redeem credit card rewards points for. Please rank the preference of the clients' over the eight offers from high to low based on the financial activities and spending habits of the client.<|eot_id|><|start_header_id|>user<|end_header_id|>
You will be presented two table of a client's transaction histories, one table for the chequing account and another table for the credit card. The first row of each table shows the name of each column and columns are separated by |. Below are the chequing account transactions.
   |transaction date|transaction category|transaction amount|
   |20xx-08-04|External Pre-Authorized Payment (Chargeable)|188.16$|
   |20xx-08-09|Cash Withdrawal from Personal Touch Banking|400.0$|
   |20xx-08-07|Internal Same-Currency Transfer using Internet Banking|2100.0$|
   |20xx-08-20|Internal Transfer of Funds to Deposit between Accounts Online|4500.0$|
   |20xx-08-07|Manual Payment of Loan using Internet Banking|1600.0$|
   |20xx-08-09|Scheduled Internal Payment to Credit Card or InvestEase|1692.99$|
. . .
Below are the credit card transactions.
   |transaction date|transaction category|transaction amount|
   |20xx-08-03|Secondhand Services|-16.01$|
   |20xx-08-03|Fast Food Services|-16.9$|
   |20xx-08-04|Industrial Services|-54.47$|
   |20xx-08-07|Airline Services|-262.12$|
   |20xx-08-07|Airline Services|-178.14$|
. . .
Please predict whether the client would be interested in redeeming the credit card reward point for flights based on the transaction history and explain the prediction with three reasons. Do not use specific numbers, transaction details or additional text in the answer.<|eot_id|><|start_header_id|>assistant<|end_header_id|>

As shown in the above example, the input prompt 216 can comprise a plurality of mapped embeddings 212 for interpretation by the LLM 206, in this case chequing account transactions and credit card transactions. In some embodiments, the plurality of mapped embeddings 212 may be concatenated or combined. It should be noted that the mapped embeddings 210 are shown in the above example in natural language rather than the embeddings form (e.g., vectors) for clarity.

As depicted in FIG. 2, the LLM 206 processes the input prompt 216 comprising the mapped embeddings 212 to generate the narratives 122. Some examples of input prompt 216 and the corresponding narratives 122 generated by the LLM 206 are shown below along with the architecture of the LLM 206. In at least some embodiments, the LLM 206 is a pre-trained LLM. The LLM 206 may be frozen during training and/or fine-tuning, as described further herein. It should be noted that the mapped embeddings 212 are shown in the below examples in natural language rather than the embeddings form (e.g., vectors) for clarity.

### Example Results for Narrative Generation

### Example 1

### Architecture:

Phi3 Mini™

### Input Prompt:

### System Prompt:

None

### Narrative Prompt:

You will be presented a table of transaction histories in a client's bank account. The first row shows the name of each column and columns are separated by |. Below is the table.
   |transaction date|transaction category|transaction amount∥20xx-06-10|Manual Transfer of Funds to Credit Card|-721.5$∥20xx-06-10|Internal Transfer of Funds to Deposit between Accounts Online|-164.2$∥20xx-06-10|Online Bill Payment using Internet Banking|-140.0$∥20xx-06-10|Deposit of Payroll, Government, Tax, and Other Funds|1678.27$∥20xx-06-10|Internal Same-Currency Transfer using Internet Banking|114.2$∥20xx-06-13|E-Transfer Received into the Account Holder's Email|81.0$∥20xx-06-13|Contactless Debit Card Purchase for Interac|-1.6$∥20xx-06-13|Debit Card Purchase for Interac Direct Payment|-39.59$∥20xx-06-15|Contactless Debit Card Purchase for Interac|-12.86$∥20xx-06-16|External Pre-Authorized Payment (Chargeable)|-268.62$∥20xx-06-17|Internal Transfer of Funds to Deposit between Accounts Online|-500.0$∥20xx-06-17|Internal Same-Currency Transfer using Internet Banking|800.0$∥20xx-06-17|Overdraft Protection Charge|-5.0$∥20xx-06-17|Interest Charged on Overdraft|-0.02$∥20xx-06-17|Debit Card Purchase for Interac Direct Payment|-4.24$∥20xx-06-17|E-Transfer Handling Fee|-3.5$| . . .
Please depict the patterns in the transactions with 5 bullet points based on the transaction history without using numbers or specific details. Enumerate the bullet points from 1 up to 5.

### Generated Narratives:

1. The client frequently engages in online bill payments and transfers funds to their credit card, indicating a reliance on digital banking services.
2. The client receives regular payroll, government, tax, and other funds, suggesting a steady income source.
3. The client makes numerous contactless debit card purchases, indicating a preference for convenient, cashless transactions.
4. The client has a pattern of making external preauthorized payments, which may be for recurring bills or subscriptions.
5. The client occasionally experiences overdraft charges, suggesting occasional cash flow issues or overspending.

### Example 2

### Architecture:

LLAMA 3.1™, 70B

### Input Prompt:

### System Prompt:

You are a expert in personal finance and banking in a Canadian bank. You will be presented with transaction histories of Canadian clients' bank accounts and asked to answer questions about the client or summarize the client profile based on their transaction history.

### Narrative Prompt:

You will be presented a table of transaction histories in a client's bank account. The first row shows the name of each column and columns are separated by |. Below is the table.
   |transaction date|transaction category|transaction amount∥20xx-06-30|Online Bill Payment using Internet Banking|-392.81$∥20xx-06-30|Online Bill Payment using Internet Banking|-275.0$∥20xx-07-04|Deposit Interest Earned on the Account Balance|0.03$∥20xx-07-04|External Pre-Authorized Payment (Chargeable)|-35.1$|20xx-07-04|External Pre-Authorized Payment (Chargeable)|-41.08$∥20xx-07-04|External Pre-Authorized Payment (Chargeable)|-189.24$∥20xx-07-05|Deposit of Payroll, Government, Tax, and Other Funds|72.67$∥20xx-07-05|Mortgage Acceleration Payment|-100.0$∥20xx-07-05|Regular Mortgage Payment|-201.71$∥20xx-07-06|Manual Transfer of Funds to Credit Card|-6.85$∥20xx-07-06|Online Bill Payment using Internet Banking|-22.87$∥20xx6-07-06|Online Bill Payment using Internet Banking|-3.33$| . . .
Please list no more than 5 sources of regular income and no more than 5 expenditure categories with large amount in the transactions without mentioning specific details or numbers. Based on the findings, estimate if the client has an overall positive or negative cash flow.

### Generated Narratives:

Based on the findings, it appears that the client has an overall positive cash flow, the client's income seems to be sufficient to cover these expenses. Additionally, the client has made several large cash or cheque deposits, which suggests that they may have a stable financial situation. However, it's worth noting that there are some instances of overdrafts and interest charges, which may indicate that the client occasionally struggles with cash flow management.

### Example 3

### Architecture:

LLAMA 3.1™, 70B

### Input Prompt:

### System Prompt:

You are an expert in personal banking, consumer behaviors, and credit card reward programs. You will be presented with the transaction histories of a Canadian client's chequing account and credit card, along with eight offers labeled from one to eight, which the client can redeem credit card reward points for. Based on the financial activities and spending habits of the client, please rank the client's preference for the eight offers from high to low. Provide your response in the format of a JSON file containing a list of items, where each item corresponds to one offer and should include the following attributes:
1) offer_id: the id of the offer as a single digit from 1 to 8;
2) offer_rank: the rank of the offer by preference as a single digit from 1 to 8, where 1 is the highest ranking and 8 is the lowest;
3) offer: the content of the offer as a string;
4) reason: the reason for the ranking of the offer as a string.
Do not include any additional text other than the JSON file.

### Narrative Prompt:

You will be presented with two tables of a client's transaction histories, one for the chequing account and another for the credit card. The first row of each table shows the name of each column, with columns separated by “I”.
Below are the chequing account transactions:
   |transaction date|transaction category|transaction amount∥20xx-08-07|Manual Transfer of Funds to Credit Card|4.65$∥20xx-08-10|Internal Same-Currency Transfer using Internet Banking|30000.0$∥20xx-08-10|All other financial activity|20641.64$∥20xx-08-10|Internal Transfer of Funds to Deposit between Accounts Online|10000.0$∥20xx-08-11|Cash Withdrawal from Personal Touch Banking|500.0$∥20xx-08-14|Internal Transfer of Funds to Deposit between Accounts Online|12000.0$∥20xx-08-14|Internal Same-Currency Transfer using Internet Banking|13000.0$∥20xx-08-15|Internal Same-Currency Transfer using Internet Banking|6000.0$∥20xx-08-15|Cheque Deposit|14100.67$∥20xx-08-15|Internal Transfer of Funds to Deposit between Accounts Online|2000.0$∥20xx-08-15|Deposit of Payroll, Government, Tax, and Other Funds|3467.8$∥20xx-08-22|Deposit of Payroll, Government, Tax, and Other Funds|19.19$∥20xx-08-24|Internal Same-Currency Transfer using Internet Banking|1600.0$∥20xx-08-24|Deposit of Payroll, Government, Tax, and Other Funds|1504.54$∥20xx-08-24|All other financial activity|33.0$∥20xx-08-24|Internal Transfer of Funds to Deposit between Accounts Online|1800.0$∥20xx-08-24|All other financial activity|30.0$∥20xx-08-24|All other financial activity|32.0$∥20xx-08-24|All other financial activity|34.0$∥20xx-08-24|All other financial activity|34.0$| . . .
Below are the credit card transactions.
   |20xx-08-07|All other categories|7.75$∥20xx-06-03|All other categories|-170.0$∥20xx-06-03|All other categories|-80.0$∥20xx-06-03|All other categories|120.0$| . . .
The eight offers to redeem credit card reward points for are:
1) use the points to pay down the loans, contribute to investment and more,
2) use the points for Bestbuy purchase,
3) use the points for car rental,
4) use a flexible amount of points for a flight with fixed value per point for redemption,
5) use a fixed amount of points for a flight with possibly higher value per point than flexible redemption,
6) use the points for home decor, sports gear and appliances,
7) pay credit card balance with the points,
8) redeem the points for gift card.

### Generated Narratives:

[
{
“offer_id”: 7,
“offer_rank”: 1,
“offer”: “pay credit card balance with the points”,
“reason”: “The client has a history of making large transactions and
transfers, indicating a high volume of financial activity. Paying off the
credit card balance would help to reduce debt and free up more funds
for future transactions.”
},
{
“offer_id”: 1,
“offer_rank”: 2,
“offer”: “use the points to pay down the loans, contribute to investment
and more”,
“reason”: “The client has a history of making large transfers and
deposits, indicating a high level of financial responsibility. Using points
to pay down loans or contribute to investments would align with this
behavior.”
},
{
“offer_id”: 8,
“offer_rank”: 3,
“offer”: “redeem the points for gift card”,
“reason”: “The client has a history of making purchases and
transactions, indicating a need for everyday items. Redeeming points
for a gift card would provide flexibility and convenience.”
},
{
“offer_id”: 6,
“offer_rank”: 4,
“offer”: “use the points for home decor, sports gear and appliances”,
“reason”: “The client has a history of making purchases and
transactions, indicating a need for everyday items. Using points for
home decor, sports gear, and appliances would align with this behavior.”
},
{
“offer_id”: 2,
“offer_rank”: 5,
“offer”: “use the points for Bestbuy purchase”,
“reason”: “The client has a history of making purchases and
transactions, indicating a need for electronics and other items. Using
points for a Bestbuy purchase would align with this behavior.”
},
{
“offer_id”: 3,
“offer_rank”: 6,
“offer”: “use the points for car rental”,
“reason”: “The client has a history of making transactions, but car rental
is not a frequent category. Using points for car rental would be less
relevant to their typical behavior.”
},
{
“offer_id”: 4,
“offer_rank”: 7,
“offer”: “use a flexible amount of points for a flight with fixed value per
point for redemption”,
“reason”: “The client has a history of making transactions, but flight
purchases are not a frequent category. Using points for a flight would
be less relevant to their typical behavior.”
},
{
“offer_id”: 5,
“offer_rank”: 8,
“offer”: “use a fixed amount of points for a flight with possibly higher
value per point than flexible redemption”,
“reason”: “The client has a history of making transactions, but flight
purchases are not a frequent category. Using points for a flight would
be less relevant to their typical behavior, and the fixed amount
requirement may be less appealing.”
}
]

As shown in FIG. 2, the LLM 206 generates the narratives 122, which can be returned to the user 102. In some embodiments, the narratives 122 may be required to be output in a specific format, for example, by the user 102 via an overall prompt to the system of FIG. 2. That is, the user 102 may specify the data representations 120 to be interpreted as well as the narrative 122 to be generated. In some embodiments, the user 102 may specify that the narratives 122 should be formatted as a text message, a Multimedia Messaging Service (MMS) message, a text/PDF file (e.g., a report), an email, etc. Further, the system of FIG. 2 can additionally perform tasks corresponding to the request of the user 102, for example, sending the narratives 122 as a message or email.

Note that while the second LLM 208 is shown and described as generating the prompts 208, a different LLM such as the LLM 206 may be used instead. Additionally, the second LLM 208 may be implemented using the same model as the LLM 206.

Note that while the embeddings 210 are described above as corresponding to a first data domain, in some embodiments, the data representations 120 may also correspond to the first data domain. In other embodiments, the data representations 120 may correspond to a data domain different from the first data domain (e.g., a third data domain) where the data processing module 202 transforms/maps the data representations 120 from the third data domain to the first data domain (e.g., as embeddings). For example, the first data domain can correspond to vector embeddings while the third data domain can correspond to natural language domain (e.g., tabular/sequential data). While the third data domain can be different from the second data domain, in some embodiments, the third data domain and the second data domain can be the same data domain (e.g., natural language domain).

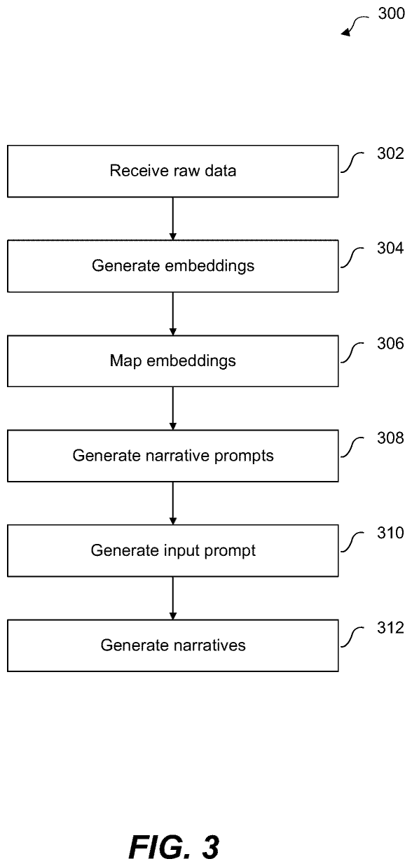

Referring now to FIG. 3, a method 300 for generating narratives from data representations using the system of FIGS. 1 and 2 is depicted, according to an example embodiment. At 302, data representations 120 comprising raw data may be received or retrieved. The data representations may pertain to a particular field and may comprise a series of events or activities. At 304, the data representations 120 may be processed by the data processing module 202 to generate embeddings 210 corresponding to the data representations 120. The data processing module 202 can be a machine learning model trained to extract embeddings 210 from the raw data representations 120, as described with respect to FIG. 2 and further herein with respect to FIG. 6. The embeddings 210 may comprise a plurality of vectors and may correspond to a first data domain. At 306, the embeddings 210 may be mapped or transformed by the adapter 204 to generate the mapped embeddings 212, corresponding to a second data domain that is recognized by the LLM 206. The adapter 204 can be an MLP network or RNN trained to perform vector mappings, as described with respect to FIG. 4. For example, the vectors comprised by the embeddings 210 may correspond to a first feature space having a first dimension, defined by the first data domain. The adapter 204 can perform vector mapping on the vectors comprised by the embeddings 210 to generate vectors corresponding to a second feature space having a second dimension, defined by the second data domain, where the mapped vectors can correspond to the mapped embeddings 212.

At 308, the one or more prompts 214 comprising the system prompt and the narrative prompt can be generated. The one or more prompts 214 can be generated according to a prompt template and may be generated using a second LLM 208. The one or more prompts 214 can comprise a first prompt corresponding to a system prompt providing the LLM 206 with background, context, or role for interpreting the data representations 120 and can, for example, identify a field relevant to the data presentations 120. The one or more prompts 214 can also comprise a second prompt corresponding to one or more narrative prompts that comprises the mapped embeddings 212; define the type(s) of narratives 122 to be generated; and/or define rules for generating the narratives 122. At 310, the input prompt 216 comprising the prompts 214 and the mapped embeddings 212 can be generated. At 312, the input prompt 216 is processed by the LLM 206 to generate the narratives 122, for example by interpreting the data representations 120 as represented by the mapped embeddings 212.

Referring now to FIG. 4, training of machine learning models to perform data representation interpretation to generate the narratives 122 is depicted, according to an example embodiment.

As depicted in FIG. 4, training data 402 comprising training data representations is obtained. The training data representations can comprise raw data and may pertain to a particular field and may comprise a series of events or activities. The training data representations 402 may be processed by the data processing module 202 to generate training embeddings 416 corresponding to the training data representations, as described above with respect to FIG. 2. The training embeddings 416 may comprise a plurality of vectors and may correspond to a first data domain . . .

During training, the adapter 204 processes the training embeddings 416 to generate training mapped or adapted embeddings 412 from the training embeddings 416. The training mapped embeddings 412 can correspond to a second data domain (e.g., vectors) the LLM 206 recognizes or is trained to operate on, or is intended for the LLM 206 to operate on. The aim of the training process is for the adapter 204 to suitably map the training embeddings 416 from the first data domain to the second data domain as the training mapped embeddings 412 such that the LLM 206 is able to interpret the training mapped embeddings 412.

The training mapped embeddings 412 and one or more prompts 404 can be used to generate a training input prompt 406. The one or more prompts 404 can comprise a first prompt corresponding to a system prompt and a second prompt corresponding to one or more narrative prompts and may be generated using the second LLM 208, as described above with respect to FIG. 2.

As depicted in FIG. 4, ground-truth narratives 408 may be provided to the LLM 206 for training as training targets. The ground-truth narratives 408 may correspond both to the training data 402 and the instructions outlined in the training input prompt 406. For example, a training input prompt 406 can comprise an instruction to: “Provide a high-level description on this client's financial behaviour”. Correspondingly, the ground-truth narratives 408 may be: “The account holder shows a balanced approach to managing income and expenses . . . ”, which can be the narratives a professional in the field would be able to interpret from the training data 402 in accordance with the requirements outlined in the training input prompt 406. Accordingly, the LLM 206 can be trained to output accurate narratives 410 based on the training input prompt 406. Note that the instruction to generate the ground-truth narratives 408 can be substantially the same as those included in the training input prompt 406 and may also be generated using the second LLM 208 in an analogous manner.

To generate the ground-truth narratives 408, data representation in the form of raw data can be used. In particular, the data representations may be in natural language or converted to natural language. For example, the data representations may comprise data corresponding to a series of sequential events where the data representations may be represented as a table in natural language format (e.g., text) identifying each event, as described above with respect to FIG. 2. A query can be generated using the text data representations and provided to the LLM 206 to generate the ground-truth narratives 408. As an example, the query can comprise the data representation in natural language such as: “Here is the personal chequing transaction history table: . . . |transaction date|transaction category|transaction amount|2021 Aug. 3|External Pre-Authorized Payment (Chargeable)|163.15$|2021 Aug. 4|Cheque Deposit|800.0$| . . . , etc.”. The LLM 206 can interpret the natural language training query as available LLMs have seen similar data during training (e.g., sequential event sequences) and as such can reason over or interpret the natural language training data to generate corresponding narratives in accordance with the instructions in the query as the ground-truth narratives 408 without supervision. Specifically, the LLM 206 is trained to ingest the training data representations (e.g., raw data), which while may be in a form such as tabular data, are still considered to be in natural language. The process for generating the query for generating the ground-truth narratives is analogous to the process of generating the input prompt 216, as described with respect to FIG. 2 with the difference being that the data representations are represented using natural language instead of mapped embeddings 212 (e.g., vectors). That is, the LLM 206 may be a pre-trained LLM that is now trained to directly recognize mapped embeddings, for example as vectors, rather than just natural language.

As depicted in FIG. 4, the LLM 206 can interpret or process the training input prompt 406 to generate narratives 410, which can be evaluated against the ground-truth narratives 408. More specifically, the system comprising the adapter 204 and the LLM 206 is trained using token representation. That is, the system is trained to predict, from the training input prompt 406, each token of the ground-truth narratives 408 in sequence, where the natural language ground-truth narratives 408 can be tokenized for training. In particular, the adapter 204 may be trained using a loss formulated as the negative log-likelihood (NLL) of each predicted token in the sequence of tokens corresponding to the ground-truth narratives 408. The loss can be used to update the parameters (e.g., weights) of the adapter 204. The LLM 206 may be frozen during the training of the adapter 204 and unfrozen during fine-tuning (e.g., after pre-training of the adapter 204) such that the adapter 204 and the LLM 206 are fine-tuned jointly. As such, weights of both the LLM 206 and the adapter 204 can be updated/modified during fine-tuning based on the loss. The joint fine-tuning can improve the LLM's ability to interpret the mapped embeddings 212. In some embodiments, the LLM 206 is frozen throughout during training and fine-tuning of the adapter 204. Once trained, even without the data representations being represented in natural language (e.g., individual events in text/table format), the LLM 206 can generate coherent and accurate narratives, for example directly from the mapped embeddings 212 (e.g., vectors).

### Example Results for LLM Training

Example ground-truth narratives 408 are shown below alongside the corresponding narratives 410 generate by the LLM 206.

### Example 1

### Ground-Truth Narratives:

Here is a high-level description on client financial situation:
The client is a frequent user of their banking services, often making multiple transactions daily, including both debit and credit card purchases, as well as transfers between accounts. They have a pattern of regular payments and scheduled transfers, indicating a structured approach to managing their finances. The client also engages in various forms of electronic payments, such as online bill payments and pre-authorized payments, suggesting a preference for convenience and automation in their financial management. They have a mix of contactless and manual transactions, showing adaptability to different payment methods. The client has a consistent pattern of depositing payroll, government, and other funds, which could imply a steady income source. Additionally, the client has a history of cash withdrawals and deposits, indicating a need for liquidity and access to their funds. Overall, this client appears to be financially active, organized, and reliant on their banking services for both personal and potentially business-related activities.

### Generated Narratives:

Here is a high-level description on client financial situation:
This client is a recurring regular banking activity with a focus on online transactions and cash withdrawals from ATM machine and contactless payments through the use of various methods such as phone app and internet banking services. They are active in managing their financial affairs and have a pattern of regular transfers between accounts and paying bills on a monthly basis. They also engage in occasional large cash withdrawals and deposits of various amounts. The client appears to be someone who values convenience and efficiency in their financial transactions, with a preference for online and mobile banking services. They are also aware of their account balances and regularly check their account activity to ensure smooth operation of their financial affairs.

### Example 2

### Ground-Truth Narratives:

Based on the transaction history, here are two patterns that can be observed:
1.**Regular income and expenses**: The client receives regular deposits, such as payroll, government, tax, and other funds, which suggests a steady income. There are also regular expenses, such as loan payments, monthly banking fees, and interest charges, which indicate a consistent pattern of financial obligations.
2.**Frequent cash withdrawals and deposits**: The client frequently withdraws cash from their account, both from the main account and from Personal Touch Banking, which suggests a need for immediate access to funds. There are also frequent cash deposits, which may indicate a need to replenish funds or make large purchases.

### Generated Narratives:

Based on the transaction history, here are two patterns that can be observed:
1.**Regular Income and Expenses**: The transactions exhibit a consistent pattern of regular income and expenses, with a clear distinction between the two. This suggests a predictable financial routine, with a steady stream of income and a corresponding allocation of funds towards various expenses.
2.**Variable Spending**: The transactions also show a pattern of variable spending, with occasional large or irregular expenses that deviate from the regular routine. This could be due to one-time purchases, unexpected expenses, or irregular financial obligations.

### Example 3

### Ground-Truth Narratives:

Is the client's financial situation improving or not?
The client's financial situation appears to be improving over time. The table shows a consistent pattern of regular deposits of payroll, government, tax, and other funds, which suggests a stable income source. Additionally, the client has made scheduled payments towards their mortgage and credit card, indicating responsible financial management. While the client's expenses also increasing, are not growing at a rate that outpaces their income, as seen by the relatively small and manageable amounts spent on bills, transfers, and other payments. The client also has a pattern of earning interest on their account balance, and there are occasional deposits of cash and e-transfers, which could indicate additional income or savings. However, there are also regular expenses such as mortgage payments, loan interest charges, and banking fees, but the overall trend of deposits and regular income sources suggest a positive financial trajectory.

### Generated Narratives:

Is the client's financial situation improving or not?
The client uses your institution for regular payments like mortgage payments (“monthly payment” and “mintuvar”), scheduled withdrawals (“daily expense tracking”), and interest accrual (“total interest accrued to date”). There are also regular deposits of payroll (“my payroll”), the results of his job (“income”, “budgeted amount”), and a mystery item “other inflows”. There are also intentional expenses like loan top-ups (“borrowed against 4013a”, “borrowed from savings”) and mortgage refinancing fees (“refinance”). The client pays for regular expenses like e-transfers (“e-transfers to himself”), credit card bills (“client statement”), and daily expenses (“daily expense tracking”).
Based on the pattern of your bank activities, I predict that the client's financial situation is improving over time. This is because there are more deposits of income (“my payroll”, “income”, “other inflows”) and regular payments towards savings and mortgage, which indicate a stable and responsible financial management. The intentional expenses like loan top-ups and mortgage refinancing fees are not frequent and could be considered as onetime expenses. The e-transfers to himself and daily expense tracking suggest that the client is managing his finances effectively and making conscious decisions to save and budget. Overall, the positive cash flows and responsible financial management indicate an improving financial situation.

In the above examples, underlined text highlights the intersection between the target (e.g., ground-truth narratives 408) and the predicted/generated narratives 410 output by the LLM 206. Overall, the LLM 206 can effectively interpret the data representations 402 to generate accurate insights in the narratives 410 to produce factual and fluent description of client embeddings.

While FIG. 4 depicts the LLM 206 being used for generating the ground-truth narratives 408 and as part of the depicted system used to generate the narratives 410, the LLM used for generating ground-truth narratives 408 can be a different LLM, such as the second LLM 208, or another LLM.

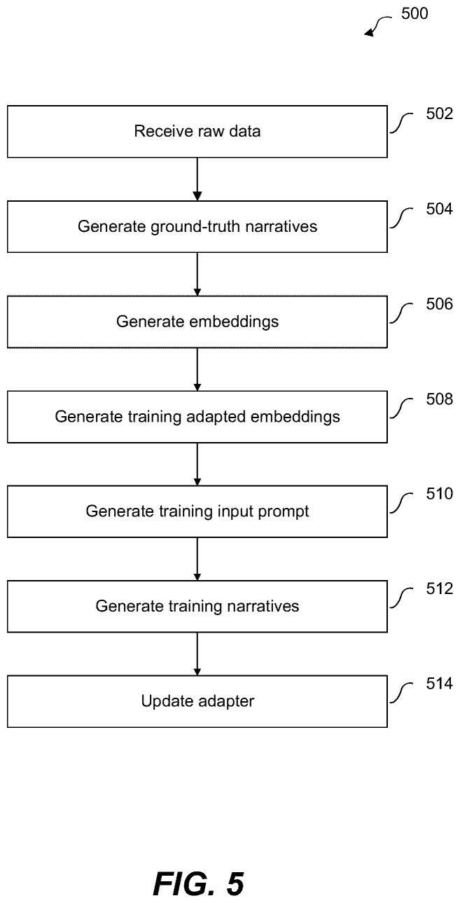

FIG. 5 depicts a method 500 for training machine learning models to perform data representation interpretation for generating the narratives 122, according to an example embodiment.

As shown in FIG. 5, training data 402 comprising data representations are received or retrieved at 502. The data representations can comprise raw data such as sequential events. At 504, ground-truth narratives 408 can be generated by processing the training data 402 (e.g., raw data) with the LLM 206 or LLM 208, as described above. Narrative generation instructions in the form of a prompt can be provided with the training data 402 to the LLM 206. At 506, the data processing module 202 can process the training data 402 to generate the training embeddings 416, as described above. The training embeddings 416 may correspond to a first data domain.

At 508, the adapter 204 generates the training adapted or mapped embeddings 412 from the training embeddings 416, as described above. The training mapped embeddings 412 can correspond to a second data domain recognized by the LLM 206 where the adapter 204 is configured to perform the mapping from the first data domain (e.g., training embeddings 416) to the second data domain (e.g., training mapped embeddings 412).

At 510, the training input prompt 406 comprising the training mapped embeddings 412 and the narrative generation instructions (e.g., prompts 404) can be generated, as described above. The narrative generation instructions can correspond to those used in the generation of the ground-truth narratives 408. The training input prompt 406 can be processed at 512 by the LLM 206 to generate the training narratives 410. At 514, the training narratives 410 can be evaluated against the ground-truth narratives 408 using a loss function. The parameters (e.g., weights) of the adapter 204 can be updated based on the loss function. The LLM 206 may be frozen during training but unfrozen for joint-tuning with the adapter 204. Accordingly, during fine-tuning, the weights for both the adapter 204 and the LLM 206 can be updated using the loss.

FIG. 6 depicts a flow chart showing an illustrative method for constructing an entity representation engine, according to an example embodiment. The entity representation engine can be a trained machine learning engine, for example corresponding to the data processing module 202. The entity representation engine can receive raw input data associated with an entity, for example data representations 120, and then generate a representation of that entity, for example as the embeddings 210.

At 602, the method receives time series training data representing a plurality of discrete training event sequences, for example, corresponding to raw data representations 120. Each training event sequence is associated with a respective one of a plurality of discrete and separate domains. The training event sequences are time-ordered sequences of sample interactions with the respective discrete separate domains. Thus, there are multiple training event sequences, and each training event sequence is associated with one of the discrete separate domains, so that multiple discrete separate domains are represented in the training event sequences.

At 604, the method applies representation learning to the time series training data received at 602 to generate a trained representation engine. Some non-limiting illustrative examples of application of representation learning to time series training data are described further below.

The trained representation engine generated at 604 is adapted to ingest entity time series data and, from the entity time series data, generate a corresponding single unified entity representation characterizing a distribution of the entity interactions with the distinct discrete domains. The entity time series data that the trained representation will ingest represents a plurality of discrete entity event sequences for a particular entity. Each entity event sequence is associated with a respective one of the distinct discrete domains, and the entity event sequences are time-ordered sequences of entity interactions for that entity with the respective distinct discrete domains. Thus, even though there are entity event sequences associated with a plurality of different distinct discrete domains, the output of the trained representation engine generated at 604 is not multiple representations, but rather a single unified entity representation. The unified entity representation may be a reduced dimensionality characterization, for example, and without limitation, a feature vector, or weights of a neural network.

That is, the data processing module 202 (e.g., the trained representation engine) can generate the single unified entity representation corresponding to the embeddings 210 from data representations 120 corresponding to a series of raw data belonging to a plurality of domains (e.g., time-series data). For example, for a time series data being a plurality of sequential financial events of various types such as credit card transactions, chequing account purchases, wire-transfers, bill payments, payroll deposits, etc., each corresponding to a different domain, the embeddings 120, generated as vectors, represent a single unified entity representation for the plurality of sequential financial events.

In some embodiments, the trained representation engine may be adapted to generate the single unified entity representation by combining a plurality of domain-specific entity representations into the single unified entity representation, for example by concatenation or aggregation, including summing and averaging.

At 606, which may be optional, the method uses labeled unified entity representation instances to train a downstream prediction model to predict an entity characteristic, for example corresponding to the embeddings 210, from an unlabeled unified entity representation instance. The labeled unified entity representation instances may be obtained by using the trained representation engine from 604 to obtain unified entity representation instances, and then applying a target label for the entity characteristic to be predicted. The entity characteristic to be predicted may be a characteristic of the entity in interacting with one of the distinct separate domains, or an aggregate statistic of the entity interactions, or another characteristic.

Some illustrative, non-limiting examples of entity characteristics are now provided. Where the entity is a hospital, the entity characteristic may be when the next patient is expected to arrive by ambulance, or the total number of patients expected in the next hour, or the gender distribution of the patients expected within the next six hours. As another example, where the entity is an individual and the data domains relate to financial transactions, the entity characteristic may be the timing and/or amount of the next credit card payment, or a total amount of deposits expected within the individual's chequing account within the next month, or the individual's credit capacity. Or, where the entity is a monitored wildlife refuge, the entity characteristic may be what type of avian is expected to arrive next, or the total number of avians expected to be present in the wildlife refuge at some future time. Where the entity is a taxicab or a ride share vehicle, the prediction may be, for example, the time of the text trip, or the distance of the next trip, or the time of the next delivery trip. Each of the foregoing is merely a non-limiting, illustrative example.

The downstream prediction model trained at 606 may be trained using any suitable machine learning technology and, unlike at 604, the prediction model trained at 606 is not limited to representation learning. For example, in one embodiment, 506 can be implemented using a multilayer perceptron (MLP), which consists of fully connected layers and non-linear layers and takes the unified entity representation as input, and directly outputs the predictions for the downstream tasks. In another embodiment, a linear transformation may be directly applied to the unified entity representation to obtain the prediction.

Some non-limiting, illustrative implementations of 604 can comprise model-specific self-supervised learning, model-agnostic self-supervised learning, and supervised learning. For example, model-specific self-supervised learning can comprise: recurrent neural network (RNN)-based self-supervised learning, meta-TPP-based self-supervised learning, conditional diffusion model for representation learning, BERT-style generative modelling, and causal attention for transformers. As another example, model-agnostic self-supervised learning can comprise: prediction of aggregated daily interactions, contrastive learning, alignment encoding, masked auto-encoding, and aggregated statistics prediction within different time windows.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification, so long as such those parts are not mutually exclusive with each other.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. Further, the singular forms “a”, “an”, and “the” are intended to include the plural forms as well, unless the context clearly indicates otherwise.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

1. A narrative generation method, comprising:
receiving data representations of a first data domain;
transforming the data representations of the first data domain by mapping the data representations of the first data domain to data representations of a second data domain using an adapter; and
generating one or more narratives corresponding to the data representations of the second data domain by interpreting the data representations of the second data domain using a large language model (LLM).

2. The method of claim 1, wherein the data representations of the first data domain comprise vector embeddings in the first data domain and the data representations of the second data domain comprise vector embeddings in the second data domain.

3. The method of claim 2, wherein the vector embeddings in the second data domain comprise language token embeddings.

4. The method of claim 2, wherein the vector embeddings in the first data domain correspond to a first vector dimension and the vector embeddings in the second data domain correspond to a second vector dimension.

5. The method of claim 4, wherein the adapter is configured to map vectors from the first vector dimension to the second vector dimension.

6. The method of claim 5, wherein the adapter is a first neural network trained to map the vectors from the first vector dimension to the second vector dimension.

7. The method of claim 6, wherein the adapter is a multi-layer perceptron network.

8. The method of claim 1, wherein the data representations of the first data domain comprise sequential events.

9. The method of claim 8, wherein the data representations of the first data domain are generated by characterizing the sequential events using a second neural network.

10. The method of claim 1, wherein generating the one or more narratives using the LLM comprises:
generating an input prompt for interpreting the data representations of the second data domain comprising the data representations of the second data domain; and
processing the input prompt with the LLM.

11. The method of claim 10, wherein the input prompt is an input vector.

12. The method of claim 10, wherein the input prompt comprises:
a first prompt for providing the LLM with background, context, or role for interpreting the data representations of the second data domain; and
a second prompt defining the one or more narratives to be generated by the LLM.

13. The method of claim 12, wherein the at second prompt is generated by a second LLM.

14. The method of claim 10,
wherein the input prompt is generated according to a prompt template comprising placeholders for the data representations of the second data domain; and
wherein the input prompt defines one or more rules for the one or more narratives.

15. The method of claim 1, wherein the adapter has been trained by:
generating ground truth narratives from training sequential events using the LLM for evaluation against the one or more narratives generated using the LLM by interpreting the data representations of the second domain.

16. The method of claim 15,
wherein each ground truth narrative comprises a sequence of tokens;
wherein the adapter has been trained by having the LLM generate tokens of the sequence of tokens in sequential order; and
wherein the adapter has been trained using a loss function comprising negative log-likelihood of the tokens.

17. The method of claim 1,
wherein the data representations of the first data domain comprise financial transactions;
wherein interpreting the data representations of the second data domain comprises processing the financial transactions using the LLM; and
wherein the one or more narratives comprise: a financial recommendation based on the financial transactions, a description of the financial transactions; an analysis of the financial transactions, or combinations thereof.

18. A method of training machine learning models for use in narrative generation, comprising:
generating ground truth narratives from a plurality of sequential events using a large language model (LLM);
training an adapter to generate data representations of a second data domain from data representations of a first data domain for interpretation by the LLM by:
generating a plurality of training data representations of the second data domain for a plurality of training data representations of the first data domain corresponding to the plurality of sequential events;
generating a plurality of training narratives by interpreting the plurality of training data representations of the second data domain using the LLM; and
updating weights of the adapter based on a comparison of the plurality of training narratives against the ground truth narratives.

19. A system for performing data interpretation, the system comprising at least one processing unit configured to perform a narrative generation method comprising:
receiving data representations of a first data domain;
transforming the data representations of the first data domain by mapping the data representations of the first data domain to data representations of a second data domain using an adapter; and
generating one or more narratives corresponding to the data representations of the second data domain by interpreting the data representations of the second data domain using a large language model (LLM).

20. At least one non-transitory computer readable medium having stored thereon computer instruction, which, when executed by at least one processor, causes the at least one processor to perform a narrative generation method, comprising:
receiving data representations of a first data domain;
transforming the data representations of the first data domain by mapping the data representations of the first data domain to data representations of a second data domain using an adapter; and
generating one or more narratives corresponding to the data representations of the second data domain by interpreting the data representations of the second data domain using a large language model (LLM).
